(19) United States
(12) Patent Application Publication
(10) Pub. No.: US 2007/0041810 A1
(43) Pub. Date: Feb. 22, 2007

(54) DEVICE AND METHOD FOR FASTENING ELECTRICAL WIRES TO FOAM CORE PANELS

(75) Inventors: Stephen Grundy, St. Augustine, FL (US); Matthew Fullenkamp, St. Augustine, FL (US)

Correspondence Address: MARK YOUNG, P.A., 12086 FORT CAROLINE ROAD, UNIT 202, JACKSONVILLE, FL, 32225, US

(73) Assignee: M.S. TECHNOLOGIES, LLC, St. Augustine, FL (US)

(21) Appl. No.: 11/460,024

(22) Filed: Jul. 26, 2006

Related U.S. Application Data
(60) Provisional application No. 60/595,904, filed on Aug. 16, 2005.

(51) Int. Cl. F16B 15/00

(52) U.S. Cl. 411/457

(57) ABSTRACT

A device for fastening an electrical wire to a foam core panel easily and effectively, without substantially compromising the foam core upon insertion, provides exceptional pull-out strength. A body comprised of a pair of substantially parallel J-shaped (or L-shaped) fastening members is joined at a proximal end by a crown. Each J-shaped (or L-shaped) fastening member is comprised of a shank and a leg, the shank being perpendicular to the crown and the leg being substantially perpendicular to the shank. Terminal tips of each member taper to a sharp point. Each leg may include one or more barbs. The device may be comprised of metal or plastic. Installation entails pushing and pivoting sections into the panel.

### RELATED APPLICATION

This application claims the benefit of priority of U.S. Provisional Application 60/595,904, filed Aug. 16, 2005, the entire contents of which are incorporated herein.

### FIELD OF THE INVENTION

This invention generally relates to electrical fastening devices, and more particularly, to a device for fastening an electrical wire to a foam core panel.

### BACKGROUND

Insulated non-structural foam core panels (i.e., “insulated panels”) are widely used in indoor construction today. Such panels are typically comprised of a solid foam core sandwiched between skin layers. The skin layers may be flexible sheets of paper, plastic, foil, sheet metal, coated textiles and other materials. The core thickness may be 0.5 inches to 1.5 inches. Advantageously, such panels provide superior insulation, in low cost, light weight, easy-to-install sections. However, they present new challenges to electricians.

Electricians secure wires at intervals (e.g., every 5 feet or so) along each free run of wire, typically by driving wire staples into wood. The staples are comprised of a pair of straight parallel legs joined at the proximal ends by a perpendicular crown. The crown of the driven staple bridges over the fastened wire without puncturing it, while the legs penetrate into the wood. Frictional engagement between the wood and legs prevents the staple from dislodging without substantial removal force. This approach provides a quick and inexpensive method to securely fasten wires when the staples are driven into wood beams.

However, staples do not work well with insulated panels. The skin and foam core provides much less frictional engagement than wood. Additionally, the skin and foam are susceptible to deformation, tearing and other modes of structural failure conducive to releasing a staple. Thus, external forces, such as the weight of the wire, vibrations and other disturbances can easily dislodged conventional staples from the foam core substrate.

Accordingly, a need exists for a device for fastening an electrical wire to a foam core panel that can be secured easily and effectively, without compromising the foam core upon insertion and with exceptional pull-out strength, and averse to “backing out” of the insertion site. The invention is directed to overcoming one or more of the problems and solving one or more of the needs as set forth above.

### SUMMARY OF THE INVENTION

In one aspect of the invention, a device for fastening an electrical wire to a foam core panel is provided. The device includes a pair of substantially parallel J-shaped (or L-shaped) fastening members each having proximal and distal ends and being joined at the proximal ends by a crown. The crown has a length and is substantially perpendicular to the pair of substantially parallel J-shaped (or L-shaped) fastening members. The distal ends terminate with tips, which may taper to a sharp point. The device may be comprised of metal or plastic.

Each J-shaped (or L-shaped) fastening member includes a shank and a leg. The shank is perpendicular to the crown and the leg is substantially perpendicular to the shank. The crown includes a first end and an opposite second end. Each shank includes a proximal end and a distal end. The shanks are substantially parallel to each other and separated by a distance defined by the length of the crown and curved shank joints.

A pair of shank joints is provided. One shank joint attaches the proximal end of one shank to the first end of the crown. The other shank joint attaches the proximal end of the other shank to the second end of the crown. The shank joints may be curved bight sections.

A pair of leg joints is also provided. Each leg includes a proximal end and a distal end. One leg joint attaches the proximal end of one leg to the distal end of one shank. The other leg joint attaches the proximal end of the other leg to the distal end of the other shank. The leg joints may be curved bight sections. The legs are substantially parallel to each other and separated by a distance defined by the length of the crown and the shank joints. The distal ends of the legs are gradually curved towards the crown. An angle between the proximal end of the leg and the distal end of the leg is between 15° and 60°.

Optionally, at least one barb may be provided on each leg. Barbs extend towards the crown and are configured to resist extraction.

The device has an effective size for securing a wire to a foam core panel. The crown is at least as wide as the electrical wire that the device is intended to fasten. The lengths of the shanks and legs are each less than (e.g., 0.35 to 0.75 times) the thickness of the foam core panel.

In another aspect of the invention, a method of securing an electrical wire to a foam core panel using a device according to principles of the invention is provided. The method entails aligning the wire between the legs of the device and between the crown of the device and the foam core panel. Then the tips are forced into the foam core panel. Then the device is pivoted in a direction from the crown, to the shanks, to the legs and to the tips. The shanks are then pushed into the core until the crown is substantially flush with the wire and the wire is sandwiched between the crown and the foam core panel.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a profile view of an exemplary device for fastening electrical wires to foam core panels in accordance with principles of the invention;

FIG. 2 is a front plan view of an exemplary device for fastening electrical wires to foam core panels in accordance with principles of the invention;

FIG. 3 is a bottom plan view of an exemplary device for fastening electrical wires to foam core panels in accordance with principles of the invention;

FIG. 4 is a perspective view of an exemplary device for fastening electrical wires to foam core panels in accordance with principles of the invention;

FIG. 5 is a flow diagram illustrating steps of an exemplary method of fastening electrical wires to foam core panels using a device in accordance with principles of the invention; and

FIG. 6 is a plan view of an exemplary device for fastening electrical wires to foam core panels installed in a foam core panel over a section of electrical wire in accordance with principles of the invention.

Those skilled in the art will appreciate that the invention is not limited to the exemplary embodiments depicted in the figures or the shapes, relative sizes, proportions or materials shown in the figures.

### DETAILED DESCRIPTION

With reference to the drawings, wherein like numerals represent like features, profile, plan and perspective views of an exemplary device for fastening electrical wires to foam core panels in accordance with principles of the invention and a method of using such an exemplary device according to principles of the invention are conceptually shown. For convenience of reference, the exemplary device is referred to herein as a claw fastener.

The claw fastener generally includes a body comprised of a pair of substantially parallel J-shaped (or L-shaped) fastening members joined at a proximal end by a crown. The fastener may be manually driven into an insulated panel by an insertion and pivoting motion, securing the fastener body in the foam core to resist inadvertent dislodging of the body.

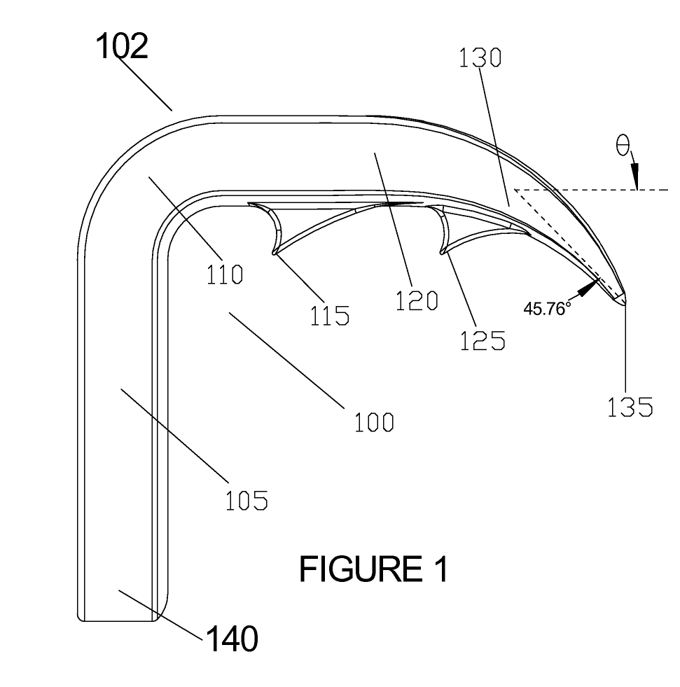

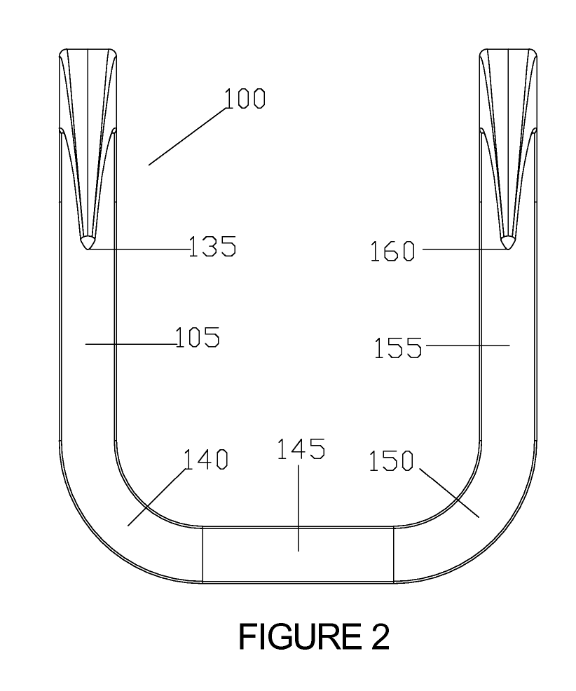

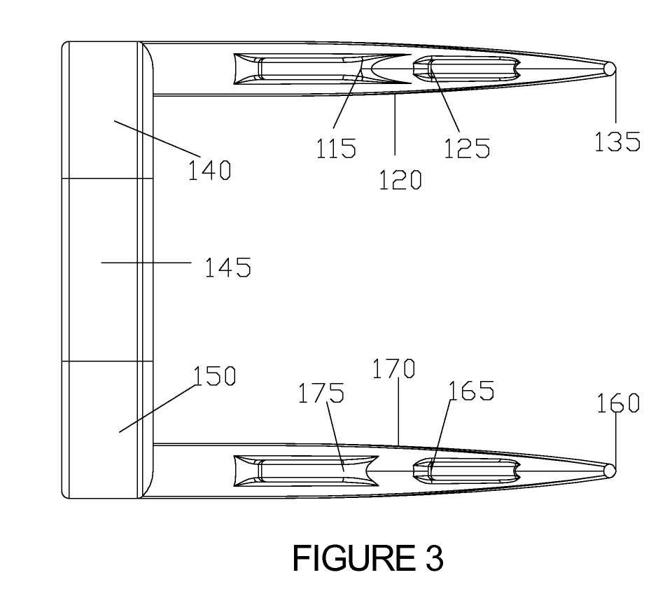

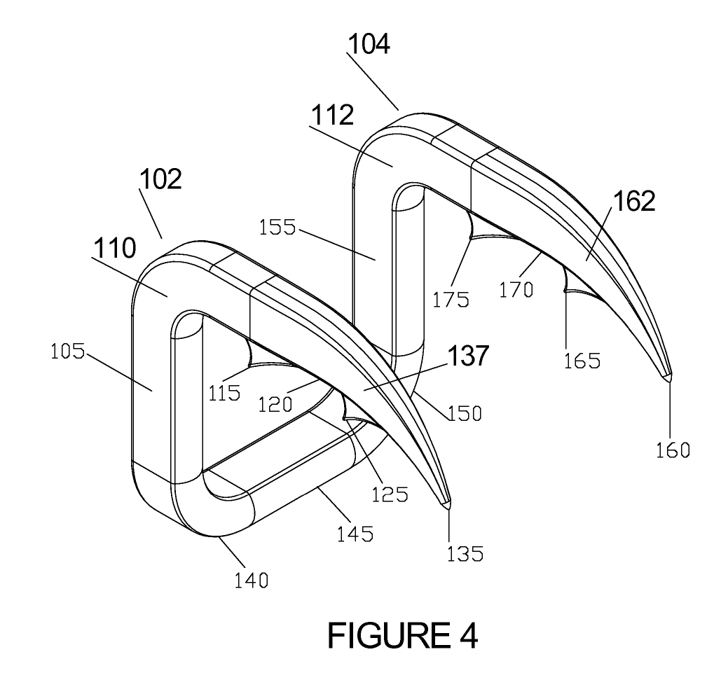

Referring now to FIGS. 1 through 4, profile, plan and perspective views of an exemplary claw fastener 100 according to principles of the invention are conceptually shown. The fastener 100 includes sections extending in 3-dimensional space. A fastener body is comprised of a pair of substantially parallel J-shaped (or L-shaped) fastening members 102, 104 which are joined by a crown 145, as shown in FIGS. 2-4. The J-shaped (or L-shaped) fastening members 102, 104 are comprised of shanks 105, 155, attached to the crown 145 by bight (curved) shank joints 140, 150. The crown 145 is a cross-member that joins the J-shaped (or L-shaped) fastening members 102, 104 together. It also serves as a brace that holds the wire against the panel. While curved shank joints 140, 150 are preferred for attaching the J-shaped (or L-shaped) fastening members 102, 104 to the crown 145, joints having other configurations such as right-angles also come within the scope of the invention. The shanks 105, 155 extend from the joints 140, 150 in a direction substantially perpendicular to the longitudinal axis of the crown 145. The shanks 105, 155 are substantially straight and parallel to each other and separated by a distance defined by the length of the crown and the curved joints 140, 150.

Each J-shaped (or L-shaped) member also includes a leg 120, 170 extending perpendicular to its respective shank 105, 155, and substantially perpendicular to the crown 145. The legs 120, 170 are attached to the shanks 105, 155 by bight (curved) leg joints 110, 112. While curved leg joints 110, 112 are preferred for attaching the legs 120, 170 to the shanks 105, 155, joints having other configurations such as right-angles also come within the scope of the invention. The legs 120, 170 are substantially parallel to each other and separated by a distance defined by the length of the crown and the curved shank joints 140, 150. The distal end of each leg 120, 170 opposite the leg joint 110, 112 may optionally include a gradual curved section 137, 162, bowed downwardly towards the crown 145. By way of illustration and not limitation, the angle θ between the horizontal portion of the leg and the bowed end may be between 15° and 60°, preferably approximately 45°. However, the invention is not limited to such curved distal ends. Instead, legs having substantially straight distal ends and distal ends with other curvatures come within the scope of the invention.

The end of each leg opposite the leg joint 110, 112 is a free end with a terminal tip 135, 160. In an exemplary embodiment, the tips 135, 160 taper to a sharp point. The tips are designed to pierce into insulated panels and form a path into which the legs 120, 170 and shanks 105, 155 may progress during installation.

One or more barbs are provided on the legs 120, 170. In an exemplary embodiment, each leg 120, 170 includes two barbs, each of which is configured to resist extraction. Illustratively, leg 120 includes first and second barbs 115, 125. Likewise, leg 170 includes first and second barbs 165, 175. The barbs 115, 125 and 165, 175 are positioned at about ⅓ and ⅔ the length of the corresponding leg. To prevent injury to hands, the barbs 115, 125 and 165, 175 preferably extend downwardly.

The exemplary claw fastener is sized for use with electrical cables. In an exemplary embodiment, the length of the crown 145 of the claw fastener 100 is effective to accommodate cables used by electricians, such as NEC type NM-B (Non-Metallic, variant B), often referred to as Romex®. Lengths of approximately 0.375 to 1.5 inches, which is greater than the width of a single strip of electrical wiring or a plurality of side-by-side strips.

In an exemplary embodiment, the lengths of the shanks 105, 155 and legs 120, 170 are less than or slightly larger than the thickness of the wire and the panel into which the fastener is installed. By way of example and not limitation, the length of each shank 105, 155, may be approximately 0.35 to 1.5 times the thickness of the foam core panel. Likewise, the length of each leg 120, 170, may be approximately 0.35 to 1.5 times the thickness of the foam core panel.

The bends 140, 150 of the claw fastener 100 between the crown 145 and shanks 105, 155 may form sharp right angles or smooth curves with a relatively large radius of curvature. The bends 110, 112 between adjoining shanks 105, 155 and legs 120, 170 are preferably not sharp right angles. Instead, smooth curve bends with a relatively large radius of curvature are preferred to facilitate entry without damaging the foam core.

The claw fastener 100 may be comprised of any material that exhibits sufficient rigidity and strength to penetrate into the core of a panel without structural failure. In an exemplary embodiment, the claw fastener 100 may be fabricated using plastic by any suitable plastic forming technique. For example, the claw fastener 100 may be comprised of a plastic or polymeric material, such as polyvinyl chloride (PVC), nylon, polysulfone, polyethylene, polypropylene, polystyrene, acrylics, cellulosics, acrylonitrile-butadiene-styrene (ABS) terpolymers, urethanes, thermo-plastic resins, thermo-plastic elastomers (TPE), acetal resins, polyamides, polycarbonates and/or polyesters. Other suitable polymeric compositions are known to those familiar with the art and may also be used in accordance with the present invention. Preferably the chosen material is relatively inexpensive, produces a rigid, durable and strong product, is easy to use in manufacturing operations and results in an aesthetically acceptable product.

The material may further include additives to provide desired properties such as desired colors, structural characteristics, glow-in-the dark properties and thermal reactivity (e.g., color changes according to heat). Illustratively, phosphorescent polymer additives, such as aluminate based phosphors, may be added to adsorb light energy and continue to release that energy as visible light, after the energy source is removed. Advantageously, such an embodiment provides a fastener that is easy to locate, enabling the fastener to shine in a dark room.

The claw fastener 100 may be produced using any suitable manufacturing techniques known in the art for the chosen material, such as (for example) injection, compression, structural foam, blow, or transfer molding; polyurethane foam processing techniques; vacuum forming; casting; and extrusion. Preferably the manufacturing technique is suitable for mass production at relatively low cost per unit, and results in an aesthetically acceptable product with a consistent acceptable quality and structural characteristics.

In an alternative embodiment, metal wire is used to form the claw fastener. By way of example and not limitation, the wire may be comprised of copper, steel, stainless steel, aluminum, an alloy or some other metal. The wire should be sufficiently thick to withstand deformation during insertion. By way of example and not limitation, 10, 12 or 14 gauge solid copper wire, such as the wire comprising Romex® cable, may be utilized.

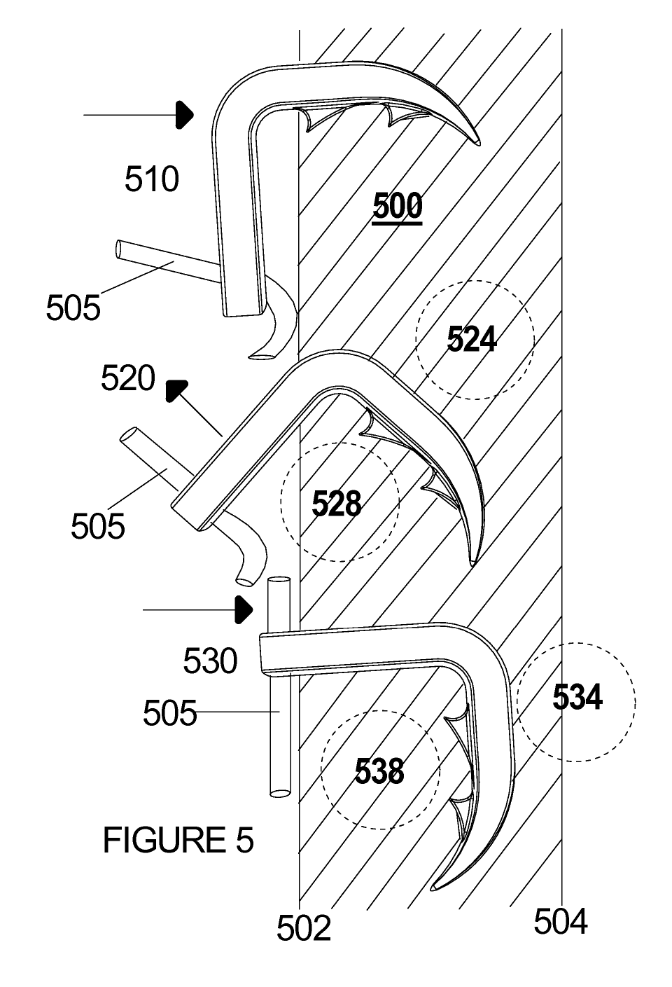

Referring now to FIG. 5, a flow diagram illustrating steps of an exemplary method of fastening electrical wires to foam core panels using a device in accordance with principles of the invention. The panel is comprised of a foam core 500 sandwiched between skins 502 and 504. However, the invention is not limited to use in connection with such panels. Those skilled in the art will appreciate that the device may be used in connection with skinless panels, panels having only one skin, and panels having a penetrable core comprised of material other than foam. Referring to step 510, during insertion, pointed tips 135, 160 are forced into and pierce the outer skin 502 and driven into the foam core 500. A pivoting motion may be utilized to facilitate entry. As the pointed tips 135, 160 progress into the foam core 500, they create a channel in the foam core 500 for the legs 120, 170. When the legs 120, 170 are inserted, the claw fastener 100 is pivoted in a direction from the crown 145 to the shanks 105, 155, to the legs 120, 170 and to the tips 135, 160, as shown in step 520. The barbs allow insertion while strongly resisting dislodgment. During pivoting of the claw fastener 100, foam core 528 beneath the legs is compressed while foam core above the legs 524 may expand slightly. Thus, insertion may continue while maintaining the foam core substantially intact. After pivoting, the shanks are pushed into the core as shown in step 530. Upon completing insertion, the crown 145 is substantially flush with the outer surface of a wire 505, which is sandwiched between the crown 145 and the outer skin 502. The foam core area 534 behind the legs 120, 170 is compressed, and the foam core 538 in front of the legs is uncompressed.

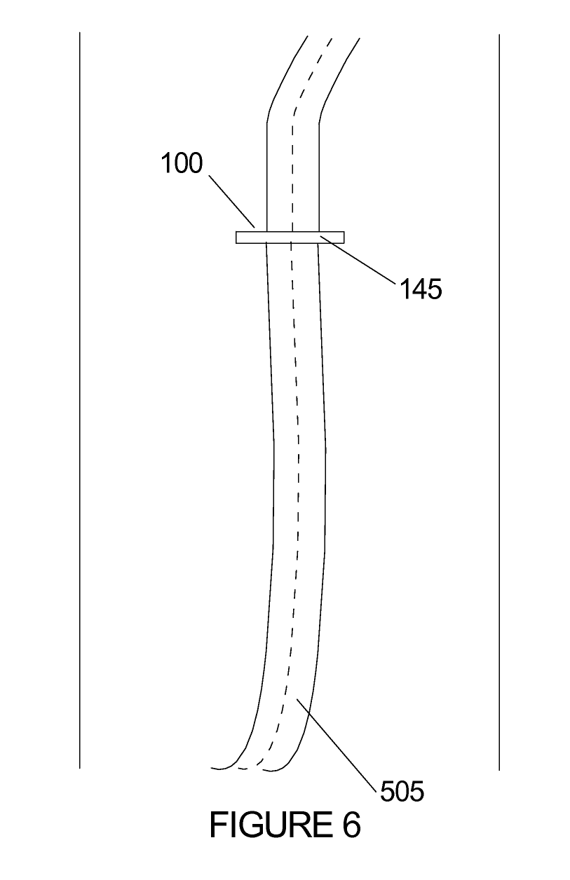

With reference to FIG. 6, a plan view of an exemplary device for fastening electrical wires to foam core panels installed in a foam core panel over a section of electrical wire in accordance with principles of the invention is shown. Upon completing insertion, the crown 145 of the claw fastener 100 is substantially flush with the outer surface of a wire 505, which is sandwiched between the crown 145 and the outer skin 502.

While the invention has been described in terms of various embodiments, implementations and examples, those skilled in the art will recognize that the invention can be practiced with modification within the spirit and scope of the appended claims including equivalents thereof. The foregoing is not intended to limit the invention to the exact construction and operation shown and described. Alternative embodiments of the invention, including variations in size, materials, components, shape, form, function, manner of operation, assembly and use that are obvious to one skilled in the art are intended to be encompassed by the invention. Accordingly, all suitable modifications and equivalents may be resorted to, falling within the scope of the invention.

While an exemplary embodiment of the invention has been described, it should be apparent that modifications and variations thereto are possible, all of which fall within the true spirit and scope of the invention. With respect to the above description then, it is to be realized that the optimum relationships for the components of the invention and steps of the process, including variations in form, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A device for fastening an electrical wire to a foam panel, said device comprising a pair of substantially parallel J-shaped fastening members each having proximal and distal ends and being joined at the proximal ends by a crown, said crown having a length and being substantially perpendicular to said pair of substantially parallel J-shaped fastening members, said distal ends terminating with tips.

2. A device for fastening an electrical wire to a foam panel according to claim 1, wherein each of said pair of substantially parallel J-shaped fastening members is comprised of a shank and a leg, said shank being perpendicular to said crown and said leg being substantially perpendicular to the shank.

3. A device for fastening an electrical wire to a foam panel according to claim 2, wherein the crown includes a first end and an opposite second end, and each shank includes a proximal end and a distal end, and the device further comprises a pair of shank joints, one shank joint attaching the proximal end of one shank to the first end of the crown, the other shank joint attaching the proximal end of the other shank to the second end of the crown.

4. A device for fastening an electrical wire to a foam panel according to claim 3, wherein the shanks are substantially parallel to each other and separated by a distance defined by the length of the crown and the curved shank joints.

5. A device for fastening an electrical wire to a foam panel according to claim 4, wherein the shank joints are curved bight sections.

6. A device for fastening an electrical wire to a foam panel according to claim 5, wherein each leg includes a proximal end and a distal end, and the device further comprises a pair of leg joints, one leg joint attaching the proximal end of one leg to the distal end of one shank, the other leg joint attaching the proximal end of the other leg to the distal end of the other shank.

7. A device for fastening an electrical wire to a foam panel according to claim 6, wherein the leg joints are curved bight sections.

8. A device for fastening an electrical wire to a foam panel according to claim 7, wherein the legs are substantially parallel to each other and separated by a distance defined by the length of the crown and the shank joints.

9. A device for fastening an electrical wire to a foam panel according to claim 8, wherein the distal ends of the legs are gradually curved towards the crown.

10. A device for fastening an electrical wire to a foam panel according to claim 9, wherein the angle between the proximal end of the leg and the distal end of the leg is between 15° and 60°.

11. A device for fastening an electrical wire to a foam panel according to claim 10, wherein the tips taper to a sharp point.

12. A device for fastening an electrical wire to a foam panel according to claim 11, further comprising at least one barb on each leg, each barb being configured to resist extraction and extending towards the crown.

13. A device for fastening an electrical wire to a foam panel according to claim 12, wherein said electrical wire has a width and the length of the crown is at least as much as a width of the electrical wire.

14. A device for fastening an electrical wire to a foam panel according to claim 13, wherein said electrical wire has a width and the length of the crown is 0.375 to 1.5 inches.

15. A device for fastening an electrical wire to a foam panel according to claim 12, wherein said foam panel has a thickness and the lengths of the shanks and legs are less than the thickness of the foam panel.

16. A device for fastening an electrical wire to a foam panel according to claim 12, wherein the lengths of the shanks and legs are each 0.35 to 1.5 times the thickness of the foam panel.

17. A device for fastening an electrical wire to a foam panel according to claim 1, wherein said device is comprised of a metal material.

18. A device for fastening an electrical wire to a foam panel according to claim 1, wherein said device is comprised of a plastic material.

19. A device for fastening an electrical wire to a foam panel according to claim 1, wherein said device is comprised of ABS.

20. A method of securing an electrical wire to a foam panel using a device according to claim 6, said method comprising
aligning the wire between the legs of the device and between the crown of the device and the foam core panel;
forcing the tips into the foam core panel;
pivoting the device in a direction from the crown, to the shanks, to the legs and to the tips;
pushing the shanks into the core until the crown is substantially flush with the wire and the wire is sandwiched between the crown and the foam core panel.
